(19) United States
(12) Patent Application Publication
(10) Pub. No.: US 2015/0032681 A1
(43) Pub. Date: Jan. 29, 2015

(54) GUIDING USES IN OPTIMIZATION-BASED PLANNING UNDER UNCERTAINTY

(71) Applicant: International Business Machines Corporation, Armonk, NY (US)

(72) Inventors: Martin Mevissen, Dublin (IR); Susara Van Den Heever, Dublin (IR); Olivier Verscheure, Meath (IR)

(21) Appl. No.: 13/948,713

(22) Filed: Jul. 23, 2013

(51) Int. Cl. G06N 5/04

(52) U.S. Cl. CPC G06N 5/048
USPC 706/52

(57) ABSTRACT

A method, system, and computer program product are disclosed for guiding users in optimization-based planning under uncertainty. In one embodiment, the invention provides a method comprising identifying one or more characterizations of a specified uncertainty in a defined process; generating a set of plans based on the uncertainty characterization; and finding a new plan based on the existing set of plans, including identifying an added constraint, and finding a new plan that satisfies this added constraint. The new plan is analyzed to determine whether the new plan satisfies defined criteria; and when the new plan satisfies the defined criteria, the new plan is added to the set of plans. One of the plans is identified as a recommended plan for the defined process. In an embodiment, the recommended plan is identified based on a trade-off analysis of the plans using at least two defined aspects of the plans.

### BACKGROUND

This invention generally relates to optimization-based planning under uncertainty, and more specifically, to a method and system to guide users in such optimization.

One of the important issues in planning is to deal with uncertainties. These uncertainties may be, for example, uncertainties in the availability and cost of raw materials, uncertainties associated with customer or client demand, or uncertainties in prices.

The main systems and methods to currently deal with planning under uncertainty are: custom mathematical models, software systems, and multi-objective interactive optimization. Custom mathematical models are used to generate a single plan which is hedged against uncertainty. Software systems are available that consider several scenarios, thus generating multiple plans which can be used as part of a “what-if” analysis. In Multi-objective interactive optimization, multiple optimal solutions are presented and user preferences are then elicited to rank these solutions so that the user can choose the best one.

Each of these methods has drawbacks. In custom mathematical models, a single optimal solution is given as a result, which is non-intuitive and often too conservative to many real-world planners who prefer to have several solutions to compare and understand why one solution was chosen above another. In software systems, multiple plans can be generated based on deterministic scenarios which do not consider uncertainty, and there are no existing software systems to guide users in choosing between those plans or finding new and improved plans. In multi-objective interactive optimization, only plans which are optimal according to a combination of predefined goals and user preferences are considered. Existing interactive systems focus on eliciting user preferences to guide the optimization approach.

### BRIEF SUMMARY

Embodiments of the invention provide a method, system and computer program product for guiding users in optimization-based planning under uncertainty. In one embodiment, the invention provides a method comprising identifying one or more characterizations of a specified uncertainty in a defined process; generating a set of plans, P, based on the uncertainty characterization; and finding a new plan, p, based on said existing set of plans, including identifying an added constraint to improve said set of plans, and finding a new plan that satisfies said added constraint. The method further comprises analyzing said new plan to determine whether said new plan satisfies defined criteria; when said new plan satisfies the defined criteria, adding the new plan to the set of plans; and identifying one of the plans of the set of plans as a recommended plan for the defined process.

In an embodiment, said identifying one of the plans of the set of plans as a recommended plan includes performing a trade-off analysis of the plans in the set of plans using at least two defined aspects of the plans.

In one embodiment, said identifying one of the plans of the set of plans as a recommended plan further includes removing selected ones of the plans from the set of plans, based on said trade-off analysis, to form a revised set of plans; and identifying one of the plans of the revised set of plans as the recommended plan for the defined process.

In one embodiment, the removing selected ones of the plans includes optimizing an output of each plan of the set of plans across alternative input data sets.

In an embodiment, the performing the trade-off analysis includes presenting a visualization of the defined aspects of the plans.

In an embodiment, the specified uncertainty is a given range for a given parameter.

In an embodiment, the specified uncertainty is calculated by using historic data.

In one embodiment, the generating a set of plans based on the uncertainty characterization includes creating a deterministic optimization model, and solving said model for each of a plurality of input data scenarios and/or each of a plurality of data ranges.

In an embodiment, the generating a set of plans based on the uncertainty characterization includes solving one or more robust formulations of a deterministic optimization model based on the uncertainty characterization.

In an embodiment, the added constraint includes one or more defined measures of robustness.

In one embodiment, the invention provides a system comprising a mechanism to analyze a set of plans and to use results of the analysis to guide users in selecting one of the set of plans, based on robustness, feasibility and optimality; and a mechanism to visualize robustness of the plans in terms of optimality and feasibility. The system further comprises a mechanism to analyze a sensitivity of the plans with respect to specified uncertain data, and to use the analysis to guide users in considering alternative data; and a mechanism for adding a constraint to the set of plans and to generate a new plan based on said set of plans and satisfying said added constraint.

In an embodiment, the mechanism to analyze the set of plans performs a trade-off analysis in terms of robustness and optimality.

In one embodiment, the mechanism to visualize robustness receives results from the mechanism to analyze the set of plans and visualizes said results in interactive graphics.

In an embodiment, the mechanism to analyze the sensitivity of the plans optimizes an outcome of the plans across alternative input data sets in order to calculate a sensitivity of the plans to changes in the input data.

In one embodiment, the added constraint uses one or more defined measures of robustness.

As mentioned above, the main systems and methods to currently deal with planning under uncertainties are mathematical models, software systems, and multi-objective interactive optimization.

Several commercial and academic software packages have robust, stochastic, and scenario optimization capabilities (e.g. AIMMS, ROME, SAMPL, and Frontline Systems), but all these report only one solution or plan, with no automated generation of multiple plans or feedback /guidance on which plan to choose or which new plan to consider.

Rockefellar and Wets (R. T. Rockafellar, R. Wets, “Scenarios and policy aggregation in optimization under uncertainty, “Mathematics of Operations Research, 1991, 16, 119-147) presented a progressive hedging method to deal with uncertainty, but their approach generates only one solution or plan, and is restricted to continuous optimization problems (linear programs).

Bertsimas and Sim (D. Bertsimas, M. Sim, “Robust Discrete Optimization and Network Flows,” Mathematical Programming 2003, 98, 49-71) presented a robust optimization method to deal with uncertainty in discrete optimization problems (IP and MIP), but their approach also generates only one solution or plan.

Interactive decision maps (A. V. Lotov et al., CC RAS, 1972) can be used to visualize conflicting goals for multiple feasible solutions. There is no guidance from the visualization to help the user select among these solutions or suggest an alternative solution, and solutions which might be infeasible in a few scenarios are not considered.

U.S. Pat. No. 5,148,365 by Ron S. Dembo; “Scenario Optimization” (1992), describes a method of optimizing scenarios individually, then assigning probabilities to each scenario, and solving a “tracking” optimization subproblem to find another solution which performs better than any of the individual scenarios. The method does not include comparison of multiple plans, and does not include guidance to the user in terms of how to create scenarios or how to guide the generation of new plans. The method is described for linear programming

Interactive optimization (e.g. Fisher, 1985) utilizes the users' knowledge to steer search algorithms towards good solutions and to formulate optimization problems. These methods focus on finding one particular solution. The focus is on eliciting user input to guide model formulation and algorithms, as opposed to providing information to guide the user.

Embodiments of the invention comprise tools and workflows which guide users in working with multiple plans under uncertainty, in order to compare plans, choose plans, define new scenarios or ranges of uncertain parameters to consider, and to create new plans. Current interactive methods require advanced insight and knowledge from the user through preference elicitation. Embodiments of this invention, instead, provide the insight to the user and guide them to make better planning decisions.

Embodiments of the invention automate the following processes: Creation of an alternative plan better hedged than existing plans; Trade-off analysis in terms of robustness, feasibility, and optimality; Creation of alternative uncertainty characterization (scenarios or ranges); and Guidance procedure to reduce the uncertainty and plans considered in order to arrive at a recommended action.

### BRIEF DESCRIPTION OF THE SEVERAL VIEWS OF THE DRAWINGS

FIG. 1 schematically depicts mechanisms that may be used in embodiments of the invention.

FIG. 2 is a diagram describing how an embodiment of the invention works.

FIG. 3 gives a development flow of an embodiment of this invention.

FIG. 4 is a runtime flow of an embodiment of the invention.

FIG. 5 shows an example development flow for a pump scheduling application in accordance with an embodiment of this invention.

FIG. 6 shows an example runtime flow for the pump scheduling application in an embodiment of the invention.

FIG. 7 shows a computing environment that may be used in the practice of this invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

This invention relates to guiding users in optimization-based planning under uncertainty. As mentioned above, one of the important issues in business planning is to deal with uncertainties. These uncertainties may be due to, for example, an inability to predict precisely the availability and cost of raw materials or of skilled workers, or to the unpredictability of customer demand for the goods or services provided by a business.

Existing interactive systems for dealing with planning under uncertainty focus on eliciting user preferences to guide the optimization approach. This invention, instead, focuses on using solution data to guide the user in the planning process.

Embodiments of the invention guide users of optimization-based planning under uncertainty. Embodiments of the invention provide workflows and tools that guide users in comparing multiple plans, choosing plans, defining new scenarios or ranges of uncertain parameters to consider, and creating new plans.

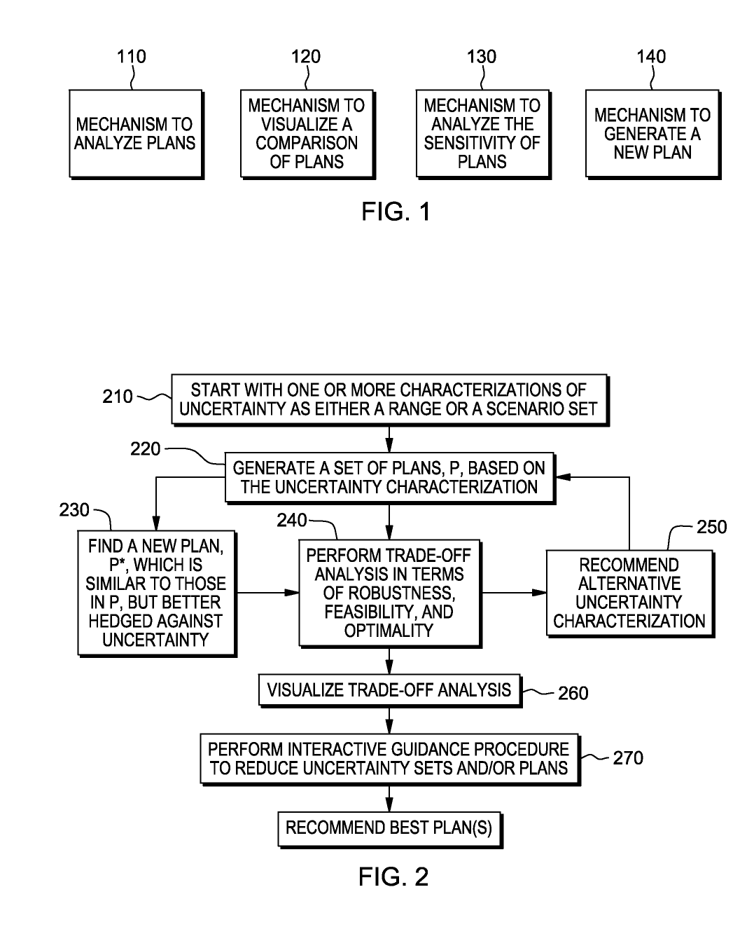

FIG. 1 illustrates several mechanisms that may be employed in this invention. Mechanism 110 is used to analyze plans and use the result of the analysis to guide users in selecting a (possibly) new plan, based on robustness, feasibility, and optimality. Mechanism 120 is provided to visualize a comparison of plans in terms of robustness, optimality, and feasibility. Mechanism 130 is used to analyze the sensitivity of plans with respect to uncertain data, and use the analysis to guide users in considering alternative data; and mechanism 140 is to generate a new plan for either mixed-integer linear programs (MIPs) or mixed-integer nonlinear programs (MINLP) based on an existing set of plans, but with improved hedging against uncertainty compared to the existing set of plans.

Embodiments of the invention may rely on an existing deterministic optimization model for the particular planning problem, an initial set of scenario data or uncertainty ranges for the deterministic model, and efficient optimization solvers for the resulting IPs, MIPs and MINLPs.

Mechanism 110 works by first optimizing (with a mathematical optimization solver engine) N deterministic mathematical optimization models corresponding to a number of input data sets and M robust and/or stochastic optimization models derived from the input data sets and/or deterministic plans N. The solutions to these (N+M) models represent (N+M) plans, which may or may not be unique. Once the (N+M) plans are known, they are substituted into each of the other (N+M−1) models, and optimized with an optimization solver engine to calculate whether the particular plan is feasible for the alternative (N+M−1) sets of input data, to calculate the objective value for the alternative (N+M−1) sets of input data, and to calculate one or more other measures of robustness for each plan.

The mechanism may make use of known measures of robustness, such as CVAR, the Conditional Value At Risk, and the Price of Robustness. With the plans and corresponding measures of feasibility and optimality calculated, the user has a measure for the robustness, i.e. the trade-off between feasibility and optimality, for each plan. The user is presented with information showing the comparison between the robustness, feasibility, and optimality of each plan. Optionally, the user can input the importance of feasibility vs optimality and the tool will then recommend one or more of the plans as satisfying this criteria. This can be done, for example, by normalizing each measure, multiplying each with the weight, and calculating the product across measures of the normalized measure and the weight. The number derived can be used to prioritize the plans according to the user requirements.

Mechanism 120 takes the plans, their objective values and measures of feasibility and robustness, as calculated by mechanism 110, and visualizes these results in interactive graphics. For example, a three-dimensional visualization with the feasibility of each plan on the y-axis, the objective value of the optimal solution to each plan on the x-axis, and the measure controlling robustness on the z-axis, with the z-axis represented as a slider as opposed to an actual 3-D axis. As the user drags the slider for the measure of robustness, different combinations of objective values and feasibility appear. The user can then drag the slider to a point they are satisfied with in terms of trade-off between optimality and feasibility across all scenarios, and then select one of the plans plotted on the 2-D graph represented by objective value and feasibility across available scenarios.

Mechanism 130 works by optimizing the outcome of the set of plans across alternative input data sets, in order to calculate how sensitive the plan is to changes in input data. For example, a given plan is combined in the original optimization model with increasing perturbations of the original input data, as well as the likelihood that the uncertain data will take those values, and optimized to the point(s) where the plan becomes infeasible. The data which resulted in infeasible solutions are then presented to the user as a data range within which the plan will remain feasible with associated likelihood. The values representing the first occurrence of infeasible solutions are presented to the user as potential input data to consider alternative data. For example, if infeasible solutions are encountered for the majority of solves at the point where tank A reaches capacity x, then the tool can recommend to the user to consider increasing the capacity of tank A to a level greater than x.

Mechanism 140 may work with known or existing methods. Known methods to generate new plans are robust and stochastic optimization methods. A new method for MIPs or MINLPs is to use the existing set of plans as input, and find another plan which is similar to the original set of plans by minimizing the Euclidian distance between the new plan and the existing plans, while satisfying only the set of constraints containing the planning variables, and adding a constraint stating that the new plan should be more robust than any of the existing plans. This added constraint can use one or more of the known measures of robustness. If this procedure results in a feasible plan, it is added to the set of plans. If it results in an infeasible plan, the violated constraints are added to the model until a feasible solution is found. This procedure is repeated a number of times, each time excluding the previously found solution by using an integer cut, until the level of robustness of the most robust plan in the original set is reached.

FIG. 2 describes, as an example, an implementation of an embodiment of this invention. Step 210 is to start with one or more characterizations of uncertainty as either a range or a scenario set. This characterization can be calculated by using historic data, known scenario generation methods, or known scenario reduction methods. Step 220 is to generate a set of plans, P, based on the uncertainty characterization. This can be done by creating a deterministic optimization model for the problem, and solving it for each input data scenario or each input data range. This can also be done with heuristic methods or simulation. This can also be done by solving one or more robust formulations of the deterministic optimization model based on the uncertainty characterization. Step 230 is to find a new plan, p*, which is similar to those in P, but better hedged against uncertainty. This can be done by using mechanism 140 described above.

Step 240 is to perform trade-off analysis in terms of robustness and optimality. This can be done by mechanism 110 described above. Step 250 is to recommend alternative uncertainty characterization. This can be done by mechanism 130 described above. Step 260 is to visualize trade-off analysis. This can be done by mechanism 120 described above. Step 270 is to perform interactive guidance procedure to reduce uncertainty sets and/or plans. This can be done by mechanisms 110 and 130 described above.

Examples of using the procedure of FIG. 2 are given below.

### Water Network Pump Scheduling for Energy Cost Minimization.

Start, at step 210, with the uncertainty characterized as a number of scenarios representing energy prices in 48 30-minute intervals for a 24 hour planning horizon. The scenarios are generated by using alternative forecasting techniques, and (optionally) a manually entered forecast. Each forecast (scenario) has an associated likelihood.

A deterministic optimization model is created for the problem at step 220, and this model is solved for each input data scenario (each forecast). This results in one schedule or plan corresponding to each of the forecasts or scenarios. At step 230, mechanism 140 is used to find a new plan or schedule. At step 240, mechanism 110 is used to determine the optimal value, number of feasible scenarios, and cost of robustness, for each of the plans The combined trade-off utility is calculated per mechanism 110 described above.

At step 250, an alternative uncertainty characterization is recommended. Sensitivity analysis per mechanism 130 is used to calculate the range of energy prices at each time period for which each plan maintains highest utility within a user-defined margin. The time period is determined with the narrowest such range, representing the most sensitive time periods, and recommended to the user to improve the forecast during those time periods. The time period is determined with the most varying ranges across scenarios and recommended to the planner to improve the forecast during those time periods, for example by negotiating a fixed contract for those time periods or by using more sophisticated forecasting algorithms. At step 260, trade-off analysis is visualized by mechanism 120 described above.

At step 270, an interactive guidance procedure is performed to reduce uncertainty sets and/or plans. This can be done by mechanisms 110 and 130 described above. For example, for the set of plans with 10% highest utility, the energy prices are perturbed to see at which point each plan ceases to be in the most robust set. The set of plans considered is reduced to those remaining feasible across the largest perturbation. The largest perturbation is reported to the planner as prices over which the solution will remain with highest utility.

### Pressure Management in Water Networks to Minimize Leakage.

This process starts, at step 210, with the uncertainty characterized as a number of scenarios representing nodal demands in the water networks in 30 minute intervals for a 24 hour planning horizon. The scenarios represent historic data collected by telemetry in urban water network. Uncertainty ranges are created for the demand at each node of the network.

A deterministic optimization model is created at step 220 for the problem of finding the optimal valve setting in order to minimize the pressure in the water network. Then M robust counterparts are created according to different robust models or different choices of parameters controlling robustness in a single mode, and each robust counterpart is solved to generate M plans. At step 230, mechanism 140 is used to find a new plan or schedule.

Mechanism 110 is used at step 240 to determine the optimal value, number of feasible scenarios, and cost of robustness, for each of the plans. The combined trade-off utility is calculated per mechanism 110 above. At step 260, a trade-off analysis is visualized for the M+N plans, where M plans generated in step 220 and N plans generated in iterations of step 230, by plotting optimal value of the robust counterpart VS percentage of feasible scenarios under the respective plan for each of the M+N plans.

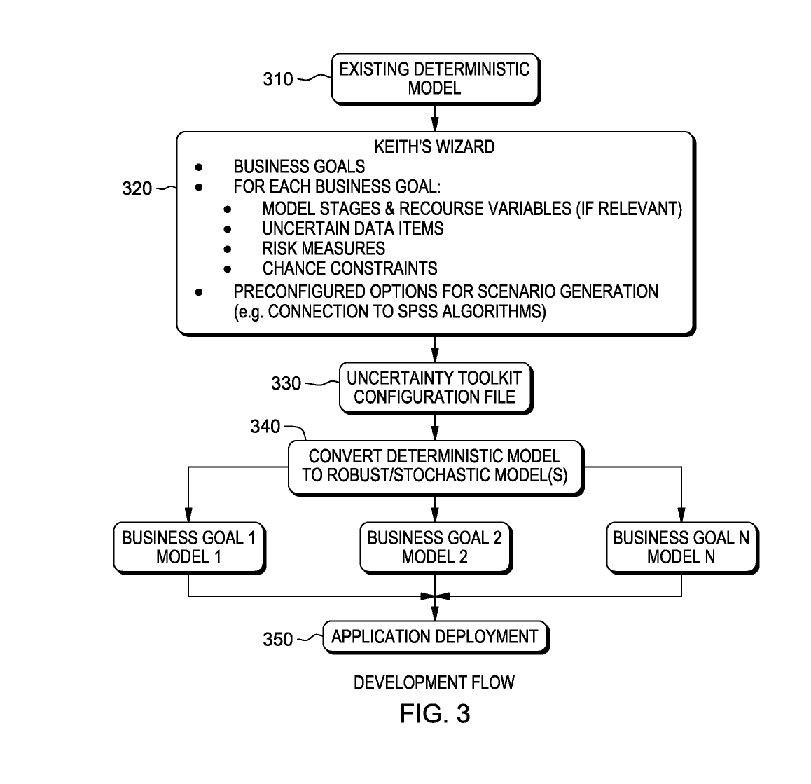

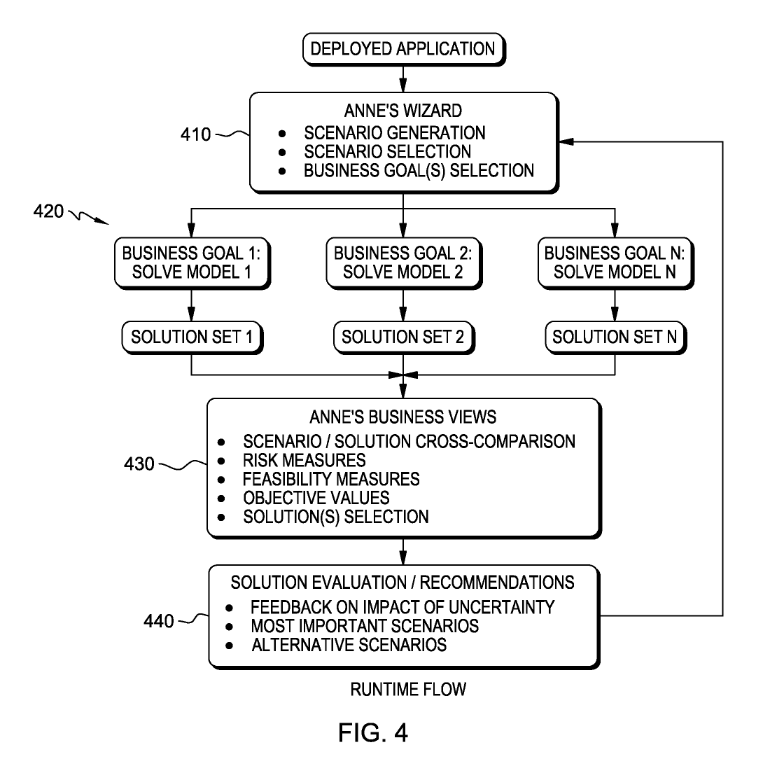

FIGS. 3 and 4 show the high-level development and runtime flow of an implementation of the system and mechanisms described above. The development flow refers to the flow of tasks which are completed by an operations research OR expert, named Keith, before he deploys the application for the business user. The runtime flow refers to the flow of tasks when the business user, named Anne, is using the system.

The flow in FIG. 3 starts, at 310, with an existing deterministic model, which could either come from an existing application, or be created by the OR expert during the development process. Once the model exists, the OR expert, at 320, uses a wizard to enter functionality to be used by the business user, such as a set of business goals, and for each business goal, associated information such as the model stages (1, 2, or more), the uncertain data items, the risk measures (e.g. CVAR or expected value), and the use of chance constraints. This information is stored, at 330, in a configuration file. Based on the configuration file, the system, at 340, converts the deterministic model into one or more robust and/or stochastic models, and stores them for later use together with the information associating each such model with business goals. One or more of the models are deployed at 350.

After deployment, the flow continues as shown in FIG. 4. The business user, at 410, uses her wizard to generate and/or select scenarios to work with, and to select one or more of the pre-configured business goals set up by the OR expert during the development process. Based on her selection, the system will either generate scenarios or allow her to select scenarios, and then, at 420, use these scenarios as input data to solve the models associated with each business goal. The solutions to the models are either stored as scenarios or as additional data which is not scenario-specific. Next, the business user, at 430, goes to her selection of business views and selects one or more views to compare, evaluate, and select solutions. The business views include scenario-solution cross-comparison, risk measures, feasibility measures, objective values, and their trade-offs. At 440, the business user can interact with these views to select a solution representing a particular level of trade-off. In addition, the system will provide the business user with feedback, for example to help her choose a solution, to consider additional scenarios, or trade-offs to consider (for example, the system can provide feedback in terms of the amount she could consider investing to improve the robustness of her plan or schedule).

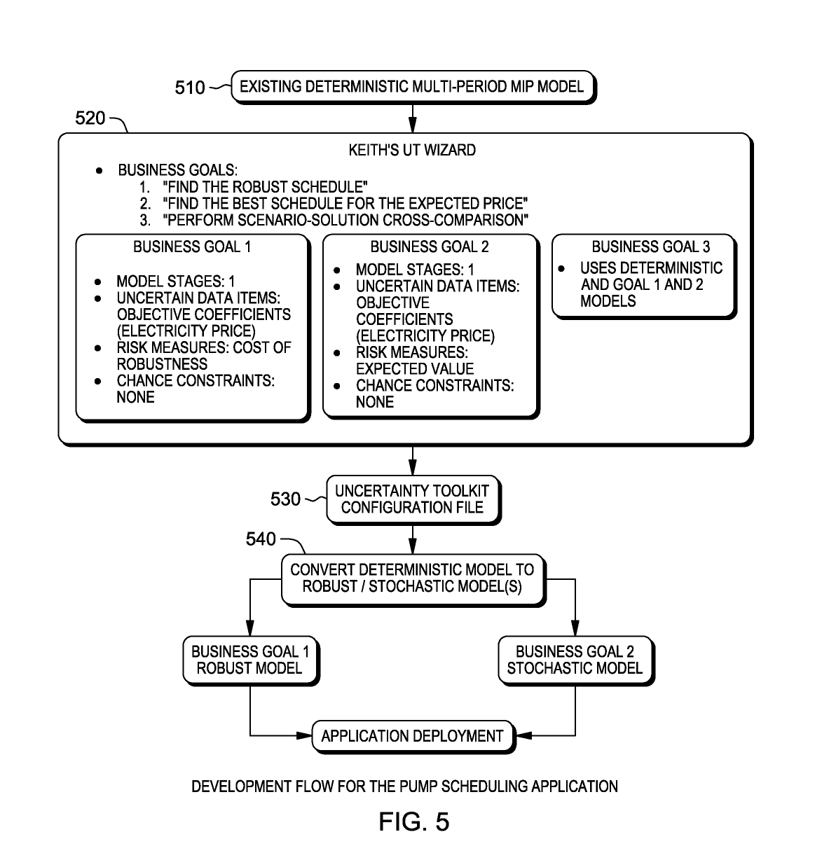

FIG. 5 shows a possible implementation of this system for the pump scheduling application described above. FIG. 5 summarizes the development flow for the pump scheduling application. The OR expert starts, at 510, with the existing multiperiod MIP model. At 520, a wizard is used to define three business goals, custom for Anne's implementation. Then, for each such business goal, the OR expert selects the number of stages, the uncertain data items, and the risk measures from the default selections provided. The OR expert does not specify chance constraints, because these are not required by Anne for this application. The OR expert also specifies pre-configured forecasting algorithms which Anne will be using for scenario creation. His choices are stored, at 530, in the configuration file, and used, at 540, to create the robust and stochastic models, and at 550, he deploys the application.

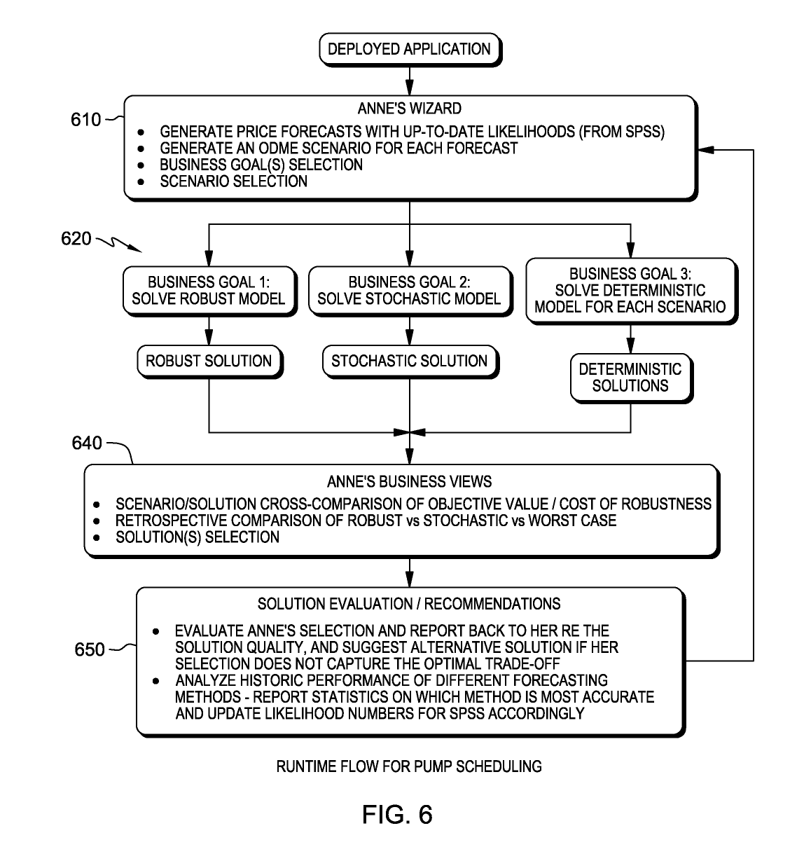

FIG. 6 shows the corresponding runtime flow for the deployed application. Based on the configuration file, Anne's wizard, at 610, presents her with choices to select one or more of the business goals specified by Keith. Depending on the selected goal, the wizard generates forecasts with the forecasting algorithms made available by the OR expert, generates a scenario for each forecast, and selects scenarios for each business goal. Next, at 620, Anne triggers each selected business goal, which results in one or more of the models being solved. The results are saved as updated or new scenarios. Now, at 640, Anne can go to her business visualization views to compare and evaluate the solutions. She looks at the scenario/solution cross-comparison view to view the comparison of the objective values and/or cost of robustness. Anne looks at the retrospective comparison view to see an update of the robust vs stochastic vs worst case outcome for previous runs, and Anne clicks on one of the solutions in the cross-comparison view to select the plan to implement. At 650, the toolkit evaluates her selection and reports back to Anne on the quality of her chosen solution, and highlights alternative solutions which might perform better (for example, solutions with a higher expected value or lower cost of robustness). Anne can now confirm whether to keep her chosen solution or change to the alternative one.

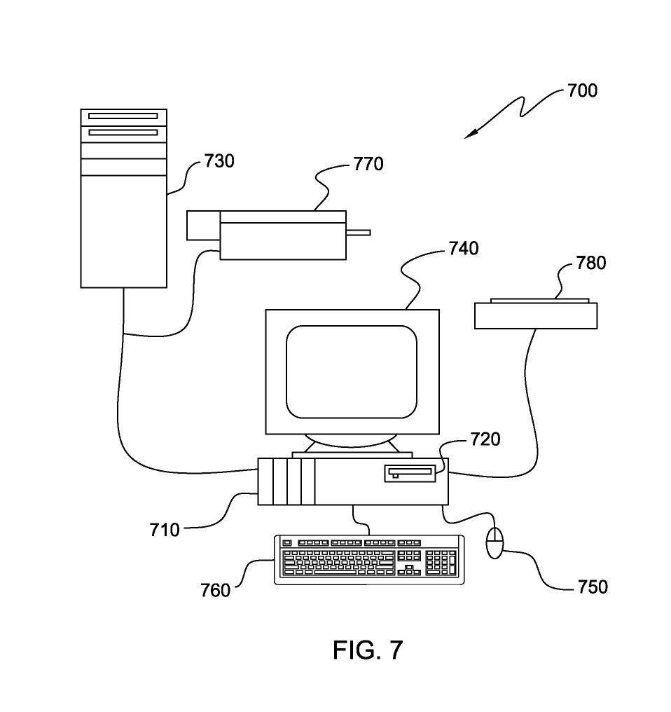

A computer-based system 700 in which embodiments of the invention may be carried out is depicted in FIG. 7. The computer-based system 700 includes a processing unit 710, which houses a processor, memory and other systems components (not shown expressly in the drawing) that implement a general purpose processing system, or a computer that may execute a computer program product. The computer program product may comprise media, for example a compact storage medium such as a compact disc, which may be read by the processing unit 710 through a disc drive 720, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 710, as mentioned, or may be located on a remote system such as a server 730, coupled to processing unit 710, via a network interface such as an Ethernet interface. Monitor 740, mouse 750 and keyboard 760 are coupled to the processing unit 710, to provide user interaction. Scanner 780 and printer 770 are provided for document input and output. Printer 170 is shown coupled to the processing unit 710 via a network connection, but may be coupled directly to the processing unit. Scanner 780 is shown coupled to the processing unit 110 directly, but it should be understood that peripherals might be network coupled, or direct coupled without affecting the performance of the processing unit 710.

While it is apparent that embodiments of the invention herein disclosed are well calculated to fulfill the features discussed above, it will be appreciated that numerous modifications and embodiments may be devised by those skilled in the art, and it is intended that the appended claims cover all such modifications and embodiments as fall within the true spirit and scope of the present invention.

1. A method of guiding users in optimization based planning under uncertainty, comprising:
identifying one or more characterizations of a specified uncertainty in a defined process;
generating a set of plans, P based on the uncertainty characterization;
finding a new plan, p, based on said existing set of plans, including identifying an added constraint to improve said set of plans, and finding a new plan that satisfies said added constraint;
analyzing said new plan to determine whether said new plan satisfies defined criteria;
when said new plan satisfies the defined criteria, adding the new plan to the set of plans;
identifying one of the plans of the set of plans as a recommended plan for the defined process.

2. The method according to claim 1, wherein said identifying one of the plans of the set of plans as a recommended plan includes performing a trade-off analysis of the plans in the set of plans using at least two defined aspects of the plans.

3. The method according to claim 2, wherein said identifying one of the plans of the set of plans as a recommended plan further includes:
based on said trade-off analysis, removing selected ones of the plans from the set of plant to form a revised set of plans; and
identifying one of the plans of the revised set of plans as the recommended plan for the defined process.

4. The method according to claim 3, wherein the removing selected ones of the plans includes optimizing an output of each plan of the set of plans across alternative input data sets.

5. The method according to claim 2, wherein the performing the trade-off analysis includes presenting a visualization of the defined aspects of the plans.

6. The method according to claim 1, wherein the specified uncertainty is a given range for a given parameter.

7. The method according to claim 1, wherein the specified uncertainty is calculated by using historic data.

8. The method according to claim 1, wherein the generating a set of plans based on the uncertainty characterization includes creating a deterministic optimization model, and solving said model for each of a plurality of input data scenarios and each of a plurality of data ranges.

9. The method according to claim 1, wherein the generating a set of plans based on the uncertainty characterization includes solving one or more robust formulations of a deterministic optimization model based on the uncertainty characterization.

10. The method according to claim 1, wherein the added constraint includes one or more defined measures of robustness.

11. A system for guiding users on optimization based planning under uncertainty, comprising:
a mechanism to analyze a set of plans and to use results of the analysis to guide users in selecting one of the set of plans, based on robustness, feasibility and optimality;
a mechanism to visualize robustness of the plans in terms of optimality an feasibility;
a mechanism to analyze a sensitivity of the plans with respect to specified uncertain data, and to use the analysis to guide users in considering alternative data; and
a mechanism for adding a constraint to the set of plans and to generate a new plan based on said set of plans and satisfying said added constraint.

12. The system according to claim 11, wherein the mechanism to analyze the set of plans performs a trade-off analysis in terms of robustness and optimality.

13. The system according to claim 11, wherein the mechanism to visualize robustness receives results from the mechanism to analyze the set of plans and visualizes said results in interactive graphics.

14. The system according to claim 11, wherein the mechanism to analyze the sensitivity of the plans optimizes an outcome of the plans across alternative input data sets in order to calculate a sensitivity of the plans to changes in the input data.

15. The system according to claim 11, wherein the added constraint uses one or more defined measures of robustness.

16. An article of manufacture comprising:
at least one tangible compute readable device having computer readable program code logic tangibly embodied therein to guide users in optimization based planning under uncertainty, the computer readable program code logic, when executing on a computer:
generating a set of plans, P, based on one or more characterizations of a specified uncertainty in a defined process;
finding a new plan, p, based on said existing set of plans, including identifying an added constraint to improve said set of plans, and finding a new plan that satisfies said added constraint;
analyzing said new plan to determine whether said new plan satisfies defined criteria;
when said new plan satisfies the defined criteria, adding the new plan to the set of plans;
identifying one of the plans of the set of plans as a recommended plan for the defined process.

17. The article of manufacture according to claim 16, wherein said identifying one of the plans of the set of plans as a recommended plan includes performing a trade-off analysis of the plans in the set of plans using at least two defined aspects of the plans.

18. The article of manufacture according to claim 17, wherein said identifying one of the plans of the set of plans as a recommended plan further includes:
based on said trade-off analysis, removing selected ones of the plans from the set of plant to form a revised set of plans; and
identifying one of the plans of the revised set of plans as the recommended plan for the defined process.

19. The article of manufacture according to claim 18, wherein the removing selected ones of the plans includes optimizing an output of each plan of the set of plans across alternative input data sets.

20. The article of manufacture according to claim 16, wherein the generating a set of plans based on the uncertainty characterization includes creating a deterministic optimization model, and solving said model for each of a plurality of input data scenarios and each of a plurality of data ranges.
